(19) United States
(12) Patent Application Publication
(10) Pub. No.: US 2012/0139470 A1
(43) Pub. Date: Jun. 7, 2012

(54) Phase Detection Methods, Apparatus, And Systems For Transport Refrigeration System

(76) Inventors: Hans-Joachim Huff, Mainz (DE); Gilbert B. Hofsdal, Chittenango, NY (US)

(21) Appl. No.: 13/389,371

(22) PCT Filed: Aug. 24, 2010
(86) PCT No.: PCT/US10/46458

§ 371 Date: Feb. 7, 2012

Related U.S. Application Data
(60) Provisional application No. 61/236,766, filed on Aug. 25, 2009.

(51) Int. Cl. H02P 1/40

(52) U.S. Cl. 318/739

(57) ABSTRACT

Transport refrigeration systems such as container refrigeration systems can operate on 3-phase power supplied by an external power supply such as in storage when powered by a generator system. If the refrigeration system is equipped with 3-phase motors, it is necessary to provide a phase detection and adjustment capability to the refrigeration system if the rotational direction of these motors is relevant to the operation of the refrigeration system. Embodiments according to the application provide systems and method for phase detection in a refrigeration system.

### CROSS REFERENCE TO RELATED APPLICATION

This application claims priority to U.S. Provisional Patent Application Ser. No. 61/236,766 entitled “Phase Detection Methods, Apparatus, and Systems for Transport Refrigeration System” filed on Aug. 25, 2009. The content of this application is incorporated herein by reference in it entirety.

### FIELD OF THE INVENTION

This invention relates generally to the field of transport refrigeration systems and methods of operating the same.

### BACKGROUND OF THE INVENTION

Transport refrigeration systems, for example, container refrigeration system can operate on 3-phase power supplied by different power systems, for instance, during transport, at a destination, in storage, or the like. If the refrigeration system is equipped with 3-phase motors, a phase detection transport and/or adjustment capability can be provided for the transport refrigeration system when the rotational direction of these motors is relevant to the operation of the refrigeration system.

### SUMMARY OF THE INVENTION

In view of the background, it is therefore an object of the present invention to provide a transport refrigeration system, transport refrigeration unit, and methods of operating same that can detect, adjust, or control an operational direction of at least one motor by selectively controlling transport refrigeration system components.

In another embodiment, the present invention includes a control module for a refrigeration system. The control module includes a controller for controlling the refrigeration system can detect proper rotational direction of a motor based on at least one sensed condition.

In another embodiment, the present invention includes a controller that can provide phase detection for a motor within a transport refrigeration system to generate a prescribed rotational direction for the motor.

In one aspect of the present invention, there is provided a method of determining whether a three phase motor is rotating in the proper direction in a transport refrigeration unit, including energizing at least one motor to operate in a first direction for a first preselected period of time, measuring a direction of air flow in the transport refrigeration unit, operating motors in the transport refrigeration unit in the first direction when the measured air flow is indicative of the proper direction, and operating the motors in a second opposite direction when the measured air flow is not indicative of the proper direction.

In another aspect of the present invention, there is provided a computer program product including a computer usable storage medium to store a computer readable program that, when executed on a computer, causes the computer to perform operations to operate a transport refrigeration unit, the operations including energize the motor to operate in a first direction for a first preselected period of time, measure a direction of air flow in the transport refrigeration unit, operate motors in the transport refrigeration unit in the first direction when the measured air flow is indicative of the proper direction, and operate the motors in a second opposite direction when the measured air flow is not indicative of the proper direction.

In another aspect of the present invention, there is provided a transport refrigeration system of the type having a plurality of three-phase motors which are periodically connected to different power sources so as to be susceptible to being connected in a phase relationship such that the motors are caused to operate in reverse including at least one measuring device proximate to a fan driven by the motors to measure a direction of air flow when at least one of the motors is operating in forward direction, a controller to determine whether the motor is operating in the proper direction responsive to the measured air flow, and the controller to operate the motors in a reverse direction when the measured air flow is indicative of an improper direction, the controller to operate the motors in the forward direction when the measured air flow is indicative of the proper direction.

### BRIEF DESCRIPTION OF THE DRAWINGS

Novel features that are characteristic of embodiments of the invention are set forth with particularity in the claims. The invention itself may be best be understood, with respect to its organization and method of operation, with reference to the following description taken in connection with the accompanying drawings in which:

FIG. 1 is a diagram that shows an exemplary embodiment of a transport refrigeration system according to the application;

FIG. 2 is a diagram that shows an embodiment of a transport refrigeration system according to the application;

FIG. 3 is a diagram that shows another embodiment of a transport refrigeration system according to the application;

FIG. 4 is a diagram that shows an additional embodiment of a transport refrigeration system according to the application; and

FIG. 5 is a flowchart that shows an embodiment of a method of operating a transport refrigeration system according to the application.

### DETAILED DESCRIPTION OF EXEMPLARY EMBODIMENTS

Reference will now be made in detail to exemplary embodiments of the application, examples of which are illustrated in the accompanying drawings. Whenever possible, the same reference numerals will be used throughout the drawings to refer to the same or like parts.

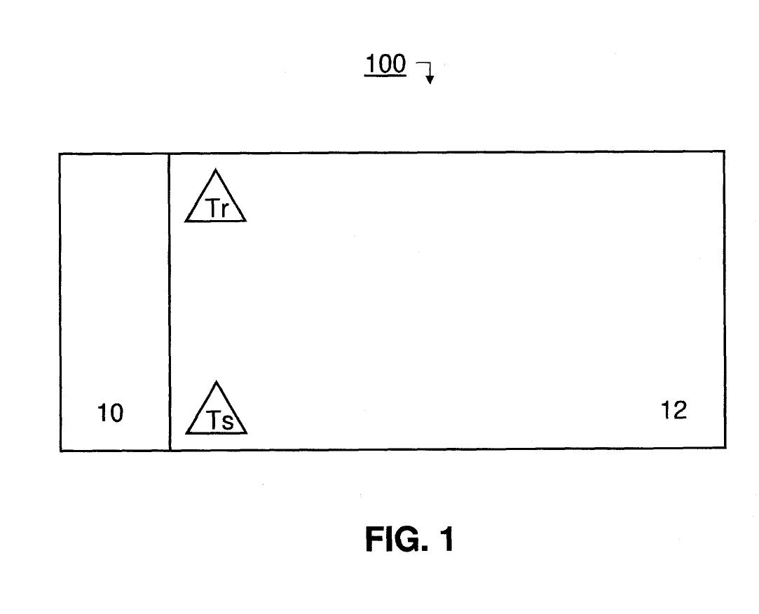

FIG. 1 is a diagram that shows an embodiment of a transport refrigeration system. As shown in FIG. 1, a transport refrigeration system 100 can include a transport refrigeration unit 10 coupled to an enclosed space within a container 12. The transport refrigeration system 100 may be of the type commonly employed on refrigerated trailers. As shown in FIG. 1, the transport refrigeration unit 10 is configured to maintain a prescribed thermal environment within the container 12 (e.g., cargo in an enclosed volume).

In FIG. 1, the transport refrigeration unit 10 is connected at one end of the container 12. Alternatively, the transport refrigeration unit 10 can be coupled to a prescribed position on a side or more than one side of the container 12. In one embodiment, a plurality of transport refrigeration units can be coupled to a single container 12. Alternatively, a single transport refrigeration unit 10 can be coupled to a plurality of containers 12. The transport refrigeration unit 10 can operate to induct air at a first temperature and to exhaust air at a second temperature. In one embodiment, the exhaust air from the transport refrigeration unit 10 will be warmer than the inducted air such that the transport refrigeration unit 10 is employed to warm the air in the container 12. In one embodiment, the exhaust air from the transport refrigeration unit 10 will be cooler than the inducted air such that the transport refrigeration unit 10 is employed to cool the air in the container 12. The transport refrigeration unit 10 can induct air from the container 12 having a return temperature Tr (e.g., first temperature) and exhaust air to the container 12 having a supply temperature Ts (e.g., second temperature).

In one embodiment, the transport refrigeration unit 10 can include one or more temperature sensors to continuously or repeatedly monitor the return temperature Tr and/or the supply temperature Ts. As shown in FIG. 1, a first temperature sensor of the transport refrigeration unit 10 can provide the supply temperature Ts and a second temperature sensor of the transport refrigeration unit 10 can provide the return temperature Tr to the transport refrigeration unit 10, respectively. Alternatively, the supply temperature Ts and the return temperature Tr can be determined using remote sensors.

A transport refrigeration system 100 can provide air with controlled temperature, humidity or/and species concentration into an enclosed chamber where cargo is stored such as in container 12. As known to one skilled in the art, the transport refrigeration system 100 (e.g., controller 250) is capable of controlling a plurality of the environmental parameters or all the environmental parameters within corresponding ranges with a great deal of variety of cargos and under all types of ambient conditions.

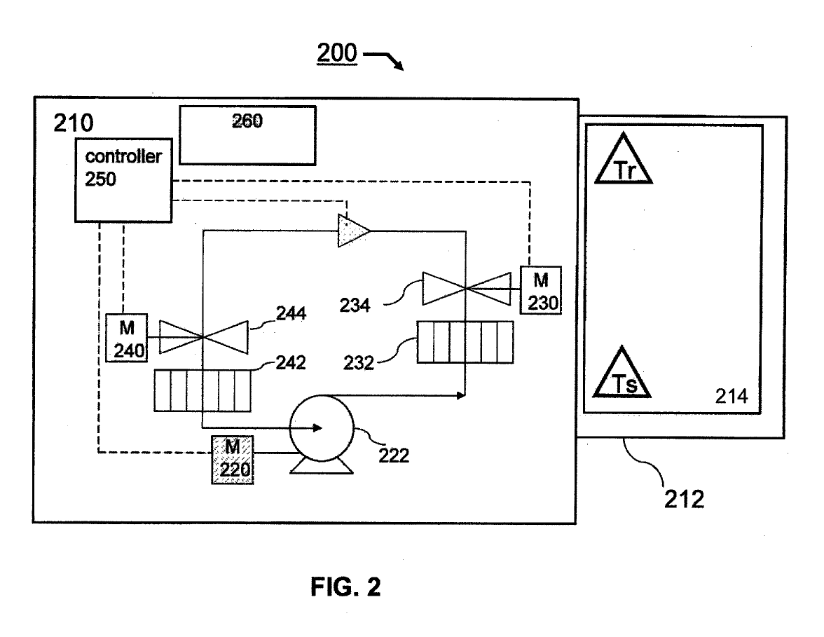

FIG. 2 is a diagram that shows an embodiment of a transport refrigeration system. As shown in FIG. 2, a transport refrigeration system 200 can include a refrigeration module 210 coupled to a container 212, which can be used with a trailer, an intermodal container, a train railcar, a ship or the like, used for the transportation or storage of goods requiring a temperature controlled environment, such as, for example foodstuffs and medicines (e.g., perishable or frozen). The container 212 can include an enclosed volume 214 for the transport/storage of such goods. The enclosed volume 214 may be an enclosed space having an interior atmosphere isolated from the outside (e.g., ambient atmosphere or conditions) of the container 212.

The refrigeration module 210 is located so as to maintain the temperature of the enclosed volume 214 of the container 212 within a predefined temperature range. In one embodiment, the refrigeration module 210 can include a compressor 222, a condenser heat exchanger unit 232, a condenser fan 234, an evaporation heat exchanger unit 242, an evaporation fan 244, and a controller 250.

The compressor 222 can be powered by three phase electrical power, and can, for example, operate at a constant or variable speed. The compressor 222 may be a scroll compressor, rotating compressor, reciprocating compressor, or the like. The transport refrigeration system 200 requires electrical power from, and can be connected to a power supply unit (not shown) such as a standard commercial power service, an external power generation system (e.g., shipboard), a generator (e.g., diesel generator), or the like.

The condenser heat exchanger unit 232 can be operatively coupled to a discharge port of the compressor 222. The evaporator heat exchanger unit 242 can be operatively coupled to an input port of the compressor 222. An expansion valve can be connected between an output of the condenser heat exchanger unit 232 and an input of the evaporator heat exchanger unit 242.

The condenser fan 234 can be positioned to direct an air stream onto the condenser heat exchanger unit 232. A motor 230 for the condenser fan can be powered by three phase electrical power. The air stream from the condenser fan 234 can allow heat to be removed from the coolant circulating within the condenser heat exchanger unit 232.

The evaporator fan 244 can be positioned to direct an air stream onto the evaporation heat exchanger unit 242. A motor 240 for the evaporator fan can be powered by three phase electrical power. The evaporator fan 244 can be located and ducted so as to circulate the air contained within the enclosed volume 214 of the container 212. In one embodiment, the evaporator fan 230 can direct the stream of air across the surface of the evaporator heat exchanger unit 242. Heat can thereby be removed from the air, and the reduced temperature air can be circulated within the enclosed volume 214 of the container 212 to lower the temperature of the enclosed volume 214.

The controller 250 such as, for example, a MicroLink.™ 2i controller available from Carrier Corporation of Syracuse, New York, USA, can be electrically connected to a motor 220 for the compressor 222, the motor 230 for the condenser fan 234, and/or the motor 240 for the evaporator fan 244. The controller 250 can be configured to operate the refrigeration module 210 to maintain a predetermined environment (e.g., thermal environment) within the enclosed volume 214 of the container 212. The controller 250 can maintain the predetermined environment by selectively controlling operations of at least one component of the transport refrigeration system 200 such as the compressor 222, the condenser fan 234, and/or the evaporator fan 244. The refrigeration module 210 is configured to maintain proper rotational direction of motors 220, 230, 240 to obtain a predetermined environment.

The refrigeration module 210 can use electrical power from, for example a normal commercial power service, a shipboard power generation system, or from a diesel generator. In the refrigeration module 210, the power to operate the compressor/fan motors of the transport refrigeration system 200 can be received from a generator or alternator that is driven by a prescribed power source (e.g., the trucks engine). However, when the prescribed power source is disconnected such as during storage, loading/unloading, additional transport, for example, an auxiliary power source, back-up power supply, external power source or a stand-by system at a remote site can provide that power. When a refrigeration module 210 is powered by generator 260 (e.g., a prescribed power source), the rotational direction of motors 220, 230, 240 can be assured.

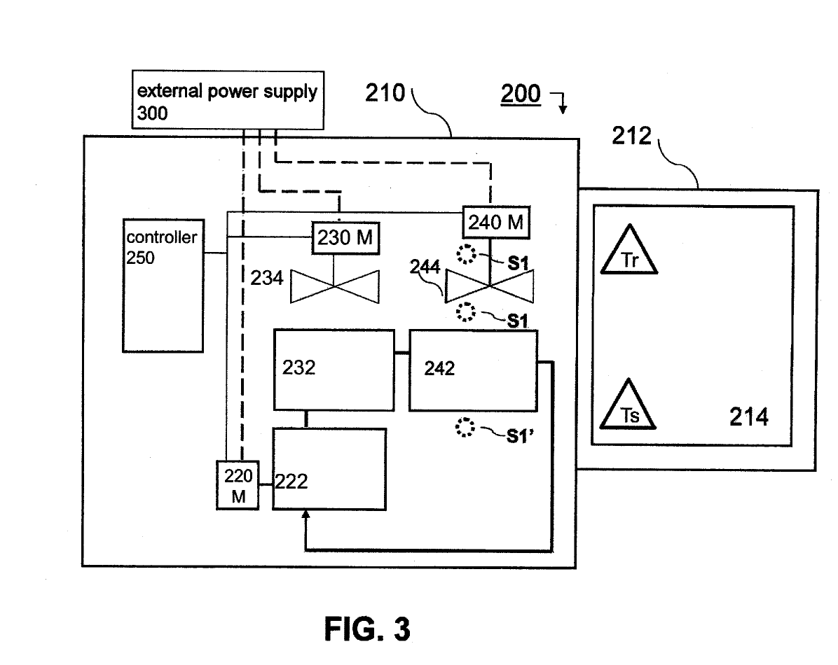

As shown in FIG. 3, when the refrigeration module 210 or transport refrigeration unit 10 is not powered by generator 260 (e.g., in storage) and operated by an external power supply 300, embodiments according to the application can provide a phase detection and adjustment capability to the refrigeration module 210 or transport refrigeration unit 10.

Embodiments according to the application can provide single operation detection for three-phase motors in a transport refrigeration system. In one embodiment, phase detection for the motors 220, 230, 240 can use air temperature change nearby a component of the refrigeration module 210. In one embodiment, phase detection for the motors 220, 230, 240 can use air temperature change at (e.g., nearby, upstream, downstream) the evaporation heat exchanger unit 244. When a fan at a heat rejection heat exchanger is driven by a three-phase motor, the temperature change of the air passing the heat rejection heat exchanger can be used as an indication for phase detection.

As described above, the refrigeration module 210 can include temperature sensors S1. When there is at least one temperature sensor S1 in the upstream (e.g., entering) air stream and at least one temperature sensor S1′ in the downstream (e.g., departing) air stream for the evaporation fan, the transport refrigeration system 100, 200 can be operated (e.g., started) in any direction and an indication can be provided or determination made whether the direction of the motors 220, 230, 240 is correct. In one embodiment, the determination can be made by the controller 250.

In one embodiment, phase detection using an air temperature change at the heat rejection evaporation heat exchanger unit 244 can be performed. To determine whether the motor 240 direction is correct using air temperature change at the heat rejection evaporation heat exchanger unit 244, at least one temperature sensor S1′ in the air stream leaving and at least one temperature sensor S1 in the air stream entering the heat evaporation exchanger unit 244 can be used. The refrigeration module 210 is operated for a period of time (e.g., started), and when the temperature of the air stream at the (nominal) outlet increases (e.g., temperature sensor S1′, the direction is correct. When the temperature at the (nominal) inlet of the heat rejection heat exchanger increases (e.g., temperature sensor S1), the direction is not correct and the opposite motor direction can be used.

In one embodiment, phase detection using an air temperature change at a heat absorption heat exchanger can be performed. To determine whether the motor direction is correct using air temperature change at a heat absorption heat exchanger, at least one temperature sensor S1 in the air stream leaving and place at least one temperature sensor S1 in the air stream entering the heat absorption heat exchanger can be used. The refrigeration module 210 is operated for a period of time (e.g., started), and when the temperature of the air stream at the (e.g., downstream) outlet decreases, the direction is correct. Alternatively, when the temperature at the (e.g., upstream) inlet of the heat absorption heat exchanger decreases, the direction is not correct, and the opposite motor direction can be used.

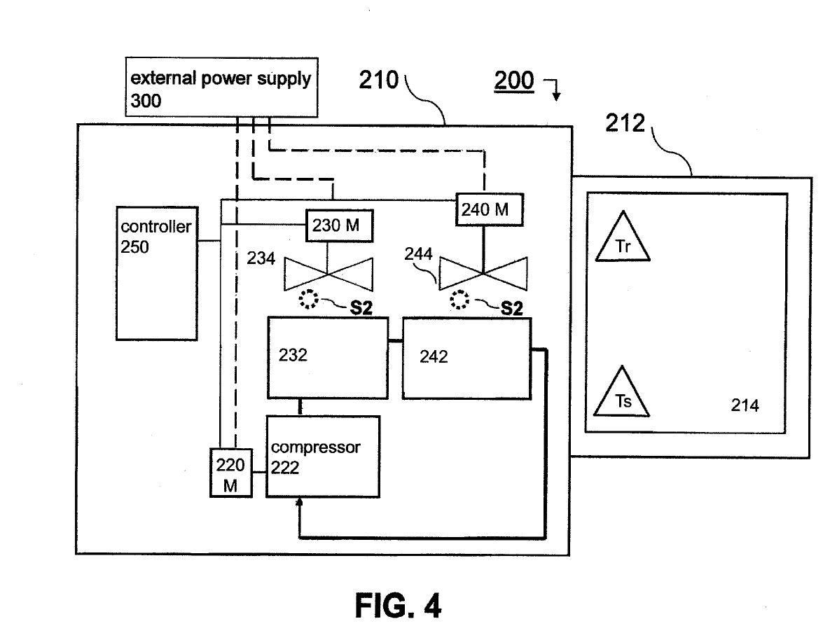

In one embodiment, phase detection for the refrigeration module (e.g., motors 220, 230, 240) can use air flow direction at a heat exchanger fan (e.g., components, condenser fan 234, evaporation fan 244). As shown in FIG. 4, a mechanism (e.g., sensor) such as one or more sensors S2 can be installed in the air stream of at least one of the heat exchanger fans, which is operable to detect the direction of the air flow. In one embodiment, exemplary mechanisms can include a flexible piece of material equipped with a strain gauge (or similar sensor) that can measure in which direction the piece of material bends where the bend is caused by air flow (e.g., when a fan is running) Alternatively, a hinged device can be used that can move the hinge depending on the direction of the air flow (e.g., when a fan is running) In one embodiment, a moveable indicator can be mounted in a channel of a sensing device so that the position of the moveable indicator reacts to determine the direction of the air flow. In one embodiment, a strain gauge (or similar sensor) can be mounted at a fan, to measure a movement, for example, mounted on the fan blade to measure the deflection of the fan blade during operation.

In one embodiment, such exemplary sensors or detection mechanisms are only monitored or has their status evaluated during a phase detection operation. In one embodiment, such air flow sensors or detection mechanisms can be reset after a reading is determined (e.g., transmitted to the controller 250). Alternatively, such exemplary sensors or detection mechanisms can be reset just prior to the phase detection operation. In one embodiment, such exemplary sensors or detection mechanisms can be reset upon startup or initialization.

In one embodiment, a mechanical sensor such as sensor S2 mounted in air flow can be evaluated to determine if an actuator in the sensor S2 is moved to a first position (e.g., closed position) where the first position of the actuator in the sensor S2 indicates the correct air flow direction (e.g., operational direction of a component or motor). Alternatively, the actuator in the sensor S2 can have at least two positions where movement to a first position indicates the correct air flow direction and movement to the second position indicates the incorrect air flow direction. Also, detection could be made between multiple one-way or single position sensors S2 to determine whether the air flow direction is correct.

In one embodiment, an optical sensor can be used for the sensor S2. For example, the optical sensor can be mounted to detect an asymmetric pattern of reflected light that varies according to the fan rotating in a forward direction or rotating in a reverse direction. Such an optical sensor could be mounted in front or behind the fan. Alternatively, the optical sensor could measure an amplitude or patterns of a sensor positioned in the air flow where the measured amplitude or corresponding detected pattern is indicative of the air flow (e.g., correct fan direction).

In one embodiment, a pressure sensor can be used for the sensor S2. For example, the pressure sensor can be mounted to detect an asymmetric air pressure across a component such as the evaporator to determine whether the motor (e.g., motor for the evaporator fan) is turning the correct direction. For example, the pressure can change (e.g., drop) as it passes over the evaporator when the motor is operating in the correct direction. However, if the motor is operating in the incorrect direction, the pressure at the top of the evaporator coil will be equal or not higher than the pressure at the bottom of the evaporator coil.

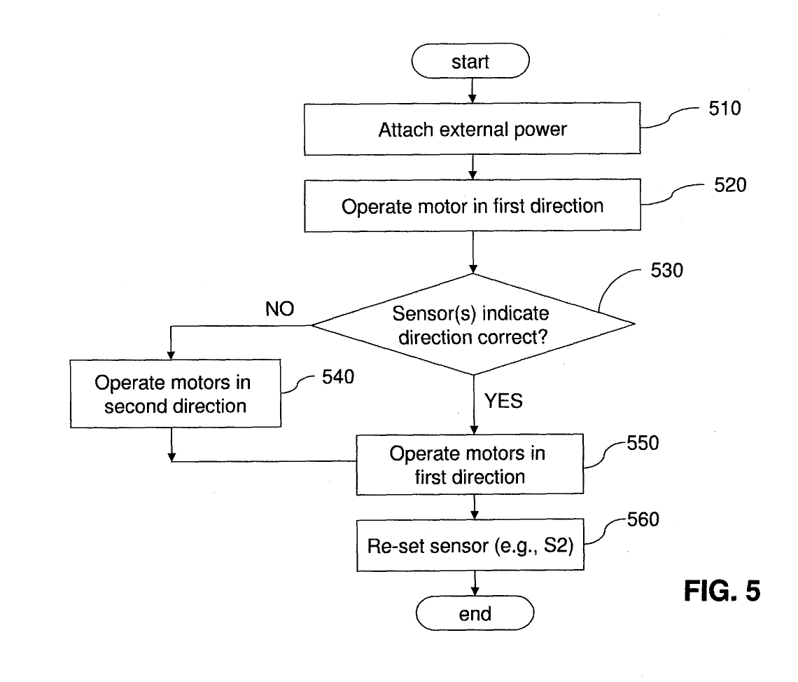

An embodiment of a method for operating a transport refrigeration system to detect power supply rotational direction for three-phase power will now be described. As shown in FIG. 5, a correct direction can be selected from a first (e.g., forward direction) operational direction and a second (e.g., reverse direction) operational direction for selected motors in transport refrigeration module 210 after operation of at least one component in the first operational direction.

As shown in FIG. 5, after a process starts, external power is connected to the motors 220, 230, 240 (block 510). Then, the system can be operated in a first direction for a prescribed period of time. Alternatively, at least one component such as one of the motors, for example, an evaporation fan motor 220 can be operated in a first direction for a prescribed period of time (block 520). At this point, a measurement detection for the operational direction of the motor 220 is performed (block 530). In one embodiment, a sensor S2 (e.g., hinge detector) mounted on the correct side (e.g., downstream side) of a heat exchanger fan is evaluated to determine if an operator in the sensor S2 is moved to the first position (e.g., closed position) where the first position of the operator in the sensor S2 indicates the correct operational direction of the evaporation fan (block 530). In one embodiment, a temperature sensor S1 is monitored to determine a temperature change in the prescribed time (block 530).

When the determination in block 530 is affirmative, the motors are operated in the first direction (block 550). When the determination in block 530 is negative, the correct direction of the motors 220, 230, 240 can be the second direction and the motors are operated in the second direction (block 540). From block 540 and block 550, control continues to optional block 560 where the sensors (e.g., 52) can be reset or disabled. From block 560, the process can end.

In one embodiment, an indicator can be enabled for the operator with notification of the correct motor direction and/or notification that the motors are operating in the correct direction (block 560). In one embodiment, a switch for a corresponding motor can be fused to the correct direction to reduce a likelihood of or prevent subsequent operation in an incorrect direction.

In one embodiment, exemplary sensors for motor phase detection (e.g., sensors S2) were described as a mechanical sensor. However, embodiments according to the application are not intended to be so limited. For example, a pressure sensor where pressure change is indicative of a proper operation of the refrigeration module 210 can be used.

According to embodiments of the application, phase detection described herein can be used as a primary determination, or a secondary (e.g., backup) determination for the refrigeration module 210.

The container 12 illustrated in FIG. 1 may be towed by a semi-truck for road transport. However, those having ordinary skill in the art will appreciate that the container of the present invention is not limited to such trailers and may encompass, by way of example only and not by way of limitation, trailers adapted for piggy-back use, railroad cars, and container bodies contemplated for land and sea service, including intermodal container. Containers as used herein may also refer to the cargo space of a truck.

In one embodiment of the refrigeration module 10 (e.g., as shown in FIG. 2), the condenser fan 234 can be replaced by a first circulating fluid heat exchanger and the evaporator fan 244 can be replaced by a second circulating fluid heat exchanger. The first circulating fluid heat exchanger can be thermally coupled to the condenser heat exchanger unit 232 to remove heat from the coolant and transfer the heat to a second circulating fluid. The second circulating fluid heat exchanger can be thermally coupled to the evaporator heat exchange unit 242 to transfer heat from a third circulating fluid within the second circulating fluid heat exchanger to the coolant within the evaporator heat exchange unit 242.

Embodiments according to the application can use sensors to respectively measure characteristics of the system such as optical patterns (e.g., by fan rotation), an air flow direction or air flow temperature within the transport refrigeration system 100. Such sensors can be remote sensors, as known to one skilled in the art that can communicate with a controller (e.g., transport refrigeration unit 10) through wire or wireless communications. For example, wireless communications can include one or more radio transceivers such as one or more of 802.11 radio transceiver, Bluetooth radio transceiver, GSM/GPS radio transceiver or WIMAX (802.16) radio transceiver. Information collected by remote sensor(s) can be used as input parameters for a controller to control various components in transport refrigeration systems.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been set forth, it will be understood that features and aspects that have been described with reference to each particular embodiment can be used with each remaining particularly set forth embodiment.

We claim:

1. A method of determining whether a three phase motor is rotating in the proper direction in a transport refrigeration unit, comprising:
energizing at least one motor to operate in a first direction for a first preselected period of time;
measuring a direction of air flow in the transport refrigeration unit;
operating motors in the transport refrigeration unit in the first direction when the measured air flow is indicative of the proper direction; and
operating the motors in a second opposite direction when the measured air flow is not indicative of the proper direction.

2. A method as set forth in claim 1, wherein said motor is a drive motor in a transport refrigeration system.

3. A method as set forth in claim 2, wherein said motor is an evaporator fan drive motor.

4. A method as set forth in claim 2, wherein said motor is a condenser fan drive motor.

5. A method as set forth in claim 2, wherein said motor is a compressor motor.

6. A method as set forth in claim 1, wherein said measuring a direction of air flow is performed by a mechanical sensor device.

7. A method as set forth in claim 5, wherein said mechanical device includes at least one of a strain gauge, a strain gauge on a fan, a strain gauge on a flexible material, a hinged device, or a floating device in channel.

8. A method as set forth in claim 7, wherein the mechanical device is reciprocally movable to at least one position indicative of a prescribed direction of the air flow.

9. A method as set forth in claim 1, wherein said motor is in a transport refrigeration system that is susceptible to being connected to a power source in reverse phase relationship.

10. A method as set forth in claim 7, wherein said measuring a direction of air flow in the transport refrigeration unit comprises at least one of measuring the direction of air flowing at the downstream side of the condenser fan after the motor is energized, measuring the direction of air flowing at the upstream side of the condenser fan after the motor is energized, measuring the direction of air flowing at the downstream side of the evaporation fan after the motor is energized, or measuring the direction of air flowing at the upstream side of the evaporation fan after the motor is energized.

11. A method as set forth in claim 1, wherein said transport refrigeration system comprises:
a compressor having a first port and a second port;
a condenser heat exchanger unit operatively coupled to said first port;
an evaporator heat exchanger unit operatively coupled to said second port;
a condenser fan disposed proximate to said condenser heat exchanger unit; and
an evaporator fan disposed proximate to said evaporator heat exchanger unit.

12. A method as set forth in claim 9, wherein said measuring a direction of air flow is performed by an optical sensor device.

13. A method as set forth in claim 12, wherein said optical sensor device detects an asymmetric pattern on a corresponding fan when the motor is operating in the first direction.

14. A computer program product comprising a computer usable storage medium to store a computer readable program that, when executed on a computer, causes the computer to perform operations to operate a transport refrigeration unit, the operations comprising:
energize said motor to operate in a first direction for a first preselected period of time;
measure a direction of air flow in the transport refrigeration unit;
operate motors in the transport refrigeration unit in the first direction when the measured air flow is indicative of the proper direction; and
operate the motors in a second opposite direction when the measured air flow is not indicative of the proper direction.

15. A transport refrigeration system of the type having a plurality of three-phase motors which are periodically connected to different power sources so as to be susceptible to being connected in a phase relationship such that the motors are caused to operate in reverse comprising:
at least one measuring device proximate to a fan driven by said motors to measure a direction of air flow when at least one of said motors is operating in forward direction;
a controller to determine whether the motor in operating in the proper direction responsive to the measured air flow; and
said controller to operate the motors in a reverse direction when the measured air flow is indicative of an improper direction, said controller to operate the motors in the forward direction when the measured air flow is indicative of the proper direction.

16. The transport refrigeration system as set forth in claim 15, wherein one of said motors is an evaporator fan drive motor or a condenser fan drive motor.

17. The transport refrigeration system as set forth in claim 15, wherein said measuring device is a mechanical sensor device, wherein said mechanical device includes at least one of a strain gauge, a strain gauge on a fan, a strain gauge on a flexible material, a hinged device, or a floating device in channel.

18. The transport refrigeration system as set forth in claim 17, wherein the mechanical device is resetably movable to at least one position indicative of a prescribed direction of the air flow.

19. The transport refrigeration system as set forth in claim 17, wherein said measuring device is an optical sensor device, wherein said optical sensor device is to detect an asymmetric pattern on a corresponding fan.
